(19) United States
(12) Patent Application Publication
(10) Pub. No.: US 2019/0394660 A1
(43) Pub. Date: Dec. 26, 2019

(54) BEAM FAILURE DETECTION PROCEDURE IN DISCONTINUOUS RECEPTION MODE

(71) Applicant: QUALCOMM Incorporated, San Diego, CA (US)

(72) Inventors: Linhai He, San Diego, CA (US); Tao Luo, San Diego, CA (US); Yan Zhou, San Diego, CA (US)

(21) Appl. No.: 16/445,049

(22) Filed: Jun. 18, 2019

Related U.S. Application Data
(60) Provisional application No. 62/688,372, filed on Jun. 21, 2018.

(51) Int. Cl. H04W 24/08; H04W 76/28; H04W 16/28

(52) U.S. Cl. CPC H04W 24/08; H04W 88/02; H04W 16/28; H04W 76/28

(57) ABSTRACT

Methods, systems, and devices for wireless communications are described. In order to support beamforming operations, communicating devices may perform beam management procedures (e.g., beam failure detection (BFD)). Some such devices may operate (e.g., at least some of the time) in a discontinuous reception (DRX) mode that includes alternating periods of activity and inactivity. Improved coordination of beam management procedures in consideration of DRX mode operation may benefit such devices. A device may identify that it is configured to operate in a DRX mode, where each DRX period includes an active duration and an inactive duration. The device may identify that it is configured to perform a BFD procedure and may monitor for beam failure in accordance with the BFD procedure during (e.g., only during) the active duration of the DRX period.

### CROSS REFERENCES

The present Application for Patent claims the benefit of U.S. Provisional Patent Application No. 62/688,372 by He et al., entitled “Beam Failure Detection Procedure in Discontinuous Reception Mode,” filed Jun. 21, 2018, assigned to the assignee hereof, and expressly incorporated herein.

### BACKGROUND

The following relates generally to wireless communications and to beam failure detection (BFD) procedures in a discontinuous reception (DRX) mode.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform-spread-OFDM (DFT-s-OFDM). A wireless multiple-access communications system may include a number of base stations or network access nodes, each simultaneously supporting communication for multiple communication devices, which may be otherwise known as user equipment (UE).

### SUMMARY

Some wireless communications systems may support communications between devices that are based on beamforming operations. For example, some frequency ranges may experience signal attenuation that would preclude communications without such beamforming operations. In order to support beamforming operations, some communicating devices may perform beam management procedures (e.g., beam failure detection (BFD)). Some such devices may also operate (e.g., at least some of the time) in a discontinuous reception (DRX) mode that includes alternating periods of activity and inactivity.

The described techniques relate to improved methods, systems, devices, and apparatuses that support beam failure detection (BFD) procedures in discontinuous reception (DRX) mode. Generally, the described techniques provide for coordination of BFD procedures in consideration of DRX mode operation. For example, a device may refrain from performing BFD during an inactive period (e.g., duration) associated with the DRX mode operation. That is, the device may monitor for beam failure during active periods of the DRX mode, where monitoring for the beam failure may include receiving reference signals over one or more beams and measuring a signal quality of the reference signal. Additionally, the device may stop a timer associated with the BFD operations during inactive periods associated with the DRX mode operation. For example, expiration of the timer may trigger a reset of a beam failure counter, and a device operating in accordance with aspects of the present disclosure may run the timer during active periods associated with the DRX mode operation (e.g., to avoid premature reset of the counter during an inactive period in which the device may not be monitoring for beam failure). Such considerations may improve battery life of a communicating device, may improve throughput for a wireless system, may reduce communication latency between DRX-operating devices, and may provide other such benefits.

A method of wireless communications at a UE is described. The method may include identifying that the UE is configured to operate in a DRX mode, where each DRX period includes an active duration and an inactive duration, identifying that the UE is configured to perform a BFD procedure, and monitoring for beam failure in accordance with the BFD procedure during the active duration of the DRX period.

An apparatus for wireless communications is described. The apparatus may include a processor, memory in electronic communication with the processor, and instructions stored in the memory. The instructions may be executable by the processor to cause the apparatus to identify that the apparatus is configured to operate in a DRX mode, where each DRX period includes an active duration and an inactive duration, identify that the apparatus is configured to perform a BFD procedure, and monitor for beam failure in accordance with the BFD procedure during the active duration of the DRX period.

Another apparatus for wireless communications is described. The apparatus may include means for identifying that the apparatus is configured to operate in a DRX mode, where each DRX period includes an active duration and an inactive duration, identifying that the apparatus is configured to perform a BFD procedure, and monitoring for beam failure in accordance with the BFD procedure during the active duration of the DRX period.

A non-transitory computer-readable medium storing code for wireless communications at a UE is described. The code may include instructions executable by a processor to identify that the UE is configured to operate in a DRX mode, where each DRX period includes an active duration and an inactive duration, identify that the UE is configured to perform a BFD procedure, and monitor for beam failure in accordance with the BFD procedure during the active duration of the DRX period.

Some examples of the method, apparatuses, and non-transitory computer-readable medium described herein may further include operations, features, means, or instructions for operating a timer in accordance with the BFD procedure, where expiration of the timer results in a beam failure counter being reset.

In some examples of the method, apparatuses, and non-transitory computer-readable medium described herein, monitoring for beam failure may include operations, features, means, or instructions for monitoring for beam failure based on the UE entering the active duration of the DRX period.

In some examples of the method, apparatuses, and non-transitory computer-readable medium described herein, monitoring for beam failure may include operations, features, means, or instructions for monitoring one or more reference signals associated with BFD, where the monitoring may be based on a periodicity of transmission of the one or more reference signals.

In some examples of the method, apparatuses, and non-transitory computer-readable medium described herein, monitoring the one or more reference signals may include operations, features, means, or instructions for performing link quality measurements based on the one or more reference signals with a same periodicity as the periodicity of transmission of the one or more reference signals.

In some examples of the method, apparatuses, and non-transitory computer-readable medium described herein, monitoring for beam failure may include operations, features, means, or instructions for monitoring one or more beams associated with BFD reference signals, where the monitoring may be based on a periodicity of an expected coherence time of the one or more beams.

In some examples of the method, apparatuses, and non-transitory computer-readable medium described herein, monitoring for beam failure may include operations, features, means, or instructions for monitoring for beam failure in accordance with a periodicity, where the periodicity may be based on (e.g., based on a maximum between) the DRX period and a shortest periodicity for transmission of BFD reference signals.

In some examples of the method, apparatuses, and non-transitory computer-readable medium described herein, monitoring for beam failure may include operations, features, means, or instructions for monitoring for beam failure in accordance with a periodicity, where the periodicity may be based on the DRX period.

Some examples of the method, apparatuses, and non-transitory computer-readable medium described herein may further include operations, features, means, or instructions for receiving an indication that the UE is to perform the BFD procedure during the active duration of the DRX period.

Some examples of the method, apparatuses, and non-transitory computer-readable medium described herein may further include operations, features, means, or instructions for receiving an indication that the UE is to operate a timer associated with the BFD procedure during (e.g., only during) the active duration of the DRX period, where expiration of the timer results in a beam failure counter being reset.

Some examples of the method, apparatuses, and non-transitory computer-readable medium described herein may further include operations, features, means, or instructions for refraining from resetting a beam failure counter during the inactive duration of the DRX period.

### BRIEF DESCRIPTION OF THE DRAWINGS

FIG. 1 illustrates an example of a wireless communications system that supports beam failure detection (BFD) procedures in discontinuous reception (DRX) mode in accordance with aspects of the present disclosure.

FIG. 2 illustrates an example of a wireless communications system that supports BFD procedures in DRX mode in accordance with aspects of the present disclosure.

FIGS. 3 and 4 illustrate examples of timing diagrams that support BFD procedures in DRX mode in accordance with aspects of the present disclosure.

FIGS. 5 and 6 show block diagrams of devices that support BFD procedures in DRX mode in accordance with aspects of the present disclosure.

FIG. 7 shows a block diagram of a communications manager that supports BFD procedures in DRX mode in accordance with aspects of the present disclosure.

FIG. 8 shows a diagram of a system including a device that supports BFD procedures in DRX mode in accordance with aspects of the present disclosure.

FIGS. 9 through 12 show flowcharts illustrating methods that support BFD procedures in DRX mode in accordance with aspects of the present disclosure.

### DETAILED DESCRIPTION

Some wireless communications systems may support communications between devices that are based on beamforming operations. For example, some frequency ranges may experience signal attenuation that would preclude communications without such beamforming operations. In order to support the beamforming operations, communicating devices may perform beam management procedures (e.g., beam failure detection (BFD)). Some such devices may operate (e.g., at least some of the time) in a discontinuous reception (DRX) mode that includes alternating periods of activity and inactivity.

In accordance with aspects of the present disclosure, a device may coordinate beam management procedures with DRX mode operation. For example, the device may refrain from performing BFD during an inactive duration (e.g., period) of the DRX mode (e.g., restricting BFD to active durations of the DRX mode). Additionally, the device may stop a timer whose expiration triggers a reset of a BFD counter when the device enters the inactive duration of the DRX mode (in order to avoid triggering the reset of the counter during the inactive duration). Such techniques (e.g., as well as other such techniques for coordinating BFD with DRX mode operation) may provide various benefits to a wireless system and also to components of a wireless system as discussed herein.

Aspects of the disclosure are initially described in the context of wireless communications systems. Aspects of the disclosure are then illustrated by and described with reference to timing diagrams. Aspects of the disclosure are further illustrated by and described with reference to apparatus diagrams, system diagrams, and flowcharts that relate to BFD procedures in DRX mode.

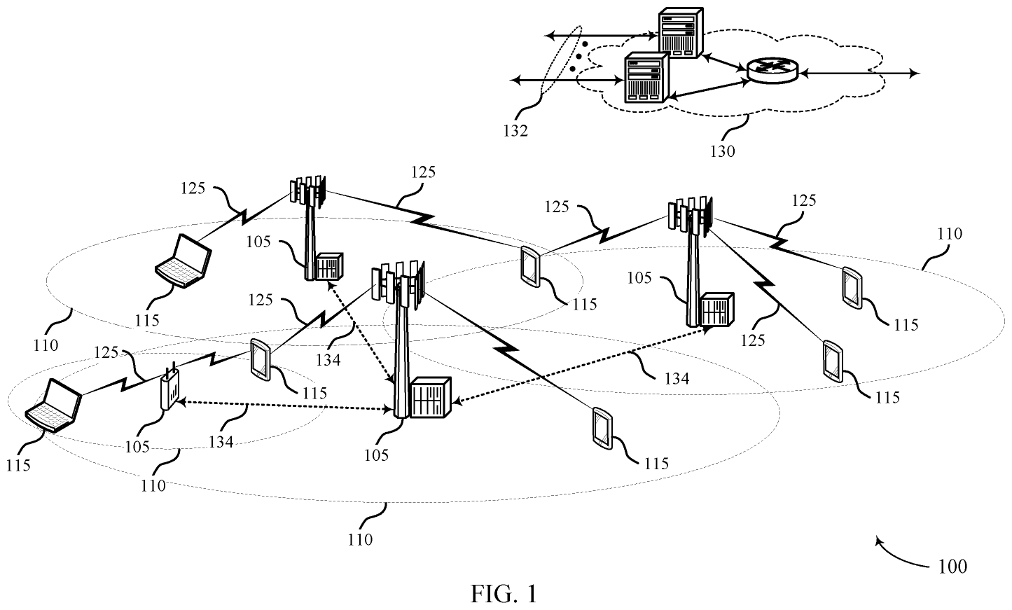

FIG. 1 illustrates an example of a wireless communications system 100 that supports BFD procedures in DRX mode in accordance with aspects of the present disclosure. The wireless communications system 100 includes base stations 105, UEs 115, and a core network 130. In some examples, the wireless communications system 100 may be a Long Term Evolution (LTE) network, an LTE-Advanced (LTE-A) network, an LTE-A Pro network, or a New Radio (NR) network. In some cases, wireless communications system 100 may support enhanced broadband communications, ultra-reliable (e.g., mission critical) communications, low latency communications, or communications with low-cost and low-complexity devices.

Base stations 105 may wirelessly communicate with UEs 115 via one or more base station antennas. Base stations 105 described herein may include or may be referred to by those skilled in the art as a base transceiver station, a radio base station, an access point, a radio transceiver, a NodeB, an eNodeB (eNB), a next-generation Node B or giga-nodeB (either of which may be referred to as a gNB), a Home NodeB, a Home eNodeB, or some other suitable terminology. Wireless communications system 100 may include base stations 105 of different types (e.g., macro or small cell base stations). The UEs 115 described herein may be able to communicate with various types of base stations 105 and network equipment including macro eNBs, small cell eNBs, gNBs, relay base stations, and the like.

Each base station 105 may be associated with a particular geographic coverage area 110 in which communications with various UEs 115 is supported. Each base station 105 may provide communication coverage for a respective geographic coverage area 110 via communication links 125, and communication links 125 between a base station 105 and a UE 115 may utilize one or more carriers. Communication links 125 shown in wireless communications system 100 may include uplink transmissions from a UE 115 to a base station 105, or downlink transmissions from a base station 105 to a UE 115. Downlink transmissions may also be called forward link transmissions while uplink transmissions may also be called reverse link transmissions.

The geographic coverage area 110 for a base station 105 may be divided into sectors making up a portion of the geographic coverage area 110, and each sector may be associated with a cell. For example, each base station 105 may provide communication coverage for a macro cell, a small cell, a hot spot, or other types of cells, or various combinations thereof In some examples, a base station 105 may be movable and therefore provide communication coverage for a moving geographic coverage area 110. In some examples, different geographic coverage areas 110 associated with different technologies may overlap, and overlapping geographic coverage areas 110 associated with different technologies may be supported by the same base station 105 or by different base stations 105. The wireless communications system 100 may include, for example, a heterogeneous LTE/LTE-A/LTE-A Pro or NR network in which different types of base stations 105 provide coverage for various geographic coverage areas 110.

The term “cell” refers to a logical communication entity used for communication with a base station 105 (e.g., over a carrier), and may be associated with an identifier for distinguishing neighboring cells (e.g., a physical cell identifier (PCID), a virtual cell identifier (VCID)) operating via the same or a different carrier. In some examples, a carrier may support multiple cells, and different cells may be configured according to different protocol types (e.g., machine-type communication (MTC), narrowband Internet-of-Things (NB-IoT), enhanced mobile broadband (eMBB), or others) that may provide access for different types of devices. In some cases, the term “cell” may refer to a portion of a geographic coverage area 110 (e.g., a sector) over which the logical entity operates.

UEs 115 may be dispersed throughout the wireless communications system 100, and each UE 115 may be stationary or mobile. A UE 115 may also be referred to as a mobile device, a wireless device, a remote device, a handheld device, or a subscriber device, or some other suitable terminology, where the “device” may also be referred to as a unit, a station, a terminal, or a client. A UE 115 may also be a personal electronic device such as a cellular phone, a personal digital assistant (PDA), a tablet computer, a laptop computer, or a personal computer. In some examples, a UE 115 may also refer to a wireless local loop (WLL) station, an Internet of Things (IoT) device, an Internet of Everything (IoE) device, or an MTC device, or the like, which may be implemented in various articles such as appliances, vehicles, meters, or the like.

Some UEs 115, such as MTC or IoT devices, may be low cost or low complexity devices, and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay that information to a central server or application program that can make use of the information or present the information to humans interacting with the program or application. Some UEs 115 may be designed to collect information or enable automated behavior of machines. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples half-duplex communications may be performed at a reduced peak rate. Other power conservation techniques for UEs 115 include entering a power saving “deep sleep” mode when not engaging in active communications, or operating over a limited bandwidth (e.g., according to narrowband communications). In some cases, UEs 115 may be designed to support critical functions (e.g., mission critical functions), and a wireless communications system 100 may be configured to provide ultra-reliable communications for these functions.

In some cases, a UE 115 may also be able to communicate directly with other UEs 115 (e.g., using a peer-to-peer (P2P) or device-to-device (D2D) protocol). One or more of a group of UEs 115 utilizing D2D communications may be within the geographic coverage area 110 of a base station 105. Other UEs 115 in such a group may be outside the geographic coverage area 110 of a base station 105, or be otherwise unable to receive transmissions from a base station 105. In some cases, groups of UEs 115 communicating via D2D communications may utilize a one-to-many (1:M) system in which each UE 115 transmits to every other UE 115 in the group. In some cases, a base station 105 facilitates the scheduling of resources for D2D communications. In other cases, D2D communications are carried out between UEs 115 without the involvement of a base station 105.

Base stations 105 may communicate with the core network 130 and with one another. For example, base stations 105 may interface with the core network 130 through backhaul links 132 (e.g., via an S1, N2, N3, or other interface). Base stations 105 may communicate with one another over backhaul links 134 (e.g., via an X2, Xn, or other interface) either directly (e.g., directly between base stations 105) or indirectly (e.g., via core network 130).

The core network 130 may provide user authentication, access authorization, tracking, Internet Protocol (IP) connectivity, and other access, routing, or mobility functions. The core network 130 may be an evolved packet core (EPC), which may include at least one mobility management entity (MME), at least one serving gateway (S-GW), and at least one Packet Data Network (PDN) gateway (P-GW). The MME may manage non-access stratum (e.g., control plane) functions such as mobility, authentication, and bearer management for UEs 115 served by base stations 105 associated with the EPC. User IP packets may be transferred through the S-GW, which itself may be connected to the P-GW. The P-GW may provide IP address allocation as well as other functions. The P-GW may be connected to the network operators IP services. The operators IP services may include access to the Internet, Intranet(s), an IP Multimedia Subsystem (IMS), or a Packet-Switched (PS) Streaming Service.

At least some of the network devices, such as a base station 105, may include subcomponents such as an access network entity, which may be an example of an access node controller (ANC). Each access network entity may communicate with UEs 115 through a number of other access network transmission entities, which may be referred to as a radio head, a smart radio head, or a transmission/reception point (TRP). In some configurations, various functions of each access network entity or base station 105 may be distributed across various network devices (e.g., radio heads and access network controllers) or consolidated into a single network device (e.g., a base station 105).

Wireless communications system 100 may operate using one or more frequency bands, typically in the range of 300 MHz to 300 GHz. Generally, the region from 300 MHz to 3 GHz is known as the ultra-high frequency (UHF) region or decimeter band, since the wavelengths range from approximately one decimeter to one meter in length. UHF waves may be blocked or redirected by buildings and environmental features. However, the waves may penetrate structures sufficiently for a macro cell to provide service to UEs 115 located indoors. Transmission of UHF waves may be associated with smaller antennas and shorter range (e.g., less than 100 km) compared to transmission using the smaller frequencies and longer waves of the high frequency (HF) or very high frequency (VHF) portion of the spectrum below 300 MHz.

Wireless communications system 100 may also operate in a super high frequency (SHF) region using frequency bands from 3 GHz to 30 GHz, also known as the centimeter band. The SHF region includes bands such as the 5 GHz industrial, scientific, and medical (ISM) bands, which may be used opportunistically by devices that can tolerate interference from other users.

Wireless communications system 100 may also operate in an extremely high frequency (EHF) region of the spectrum (e.g., from 30 GHz to 300 GHz), also known as the millimeter band. In some examples, wireless communications system 100 may support millimeter wave (mmW) communications between UEs 115 and base stations 105, and EHF antennas of the respective devices may be even smaller and more closely spaced than UHF antennas. In some cases, this may facilitate use of antenna arrays within a UE 115. However, the propagation of EHF transmissions may be subject to even greater atmospheric attenuation and shorter range than SHF or UHF transmissions. Techniques disclosed herein may be employed across transmissions that use one or more different frequency regions, and designated use of bands across these frequency regions may differ by country or regulating body.

In some cases, wireless communications system 100 may utilize both licensed and unlicensed radio frequency spectrum bands. For example, wireless communications system 100 may employ License Assisted Access (LAA), LTE-Unlicensed (LTE-U) radio access technology, or NR technology in an unlicensed band such as the 5 GHz ISM band. When operating in unlicensed radio frequency spectrum bands, wireless devices such as base stations 105 and UEs 115 may employ listen-before-talk (LBT) procedures to ensure a frequency channel is clear before transmitting data. In some cases, operations in unlicensed bands may be based on a CA configuration in conjunction with CCs operating in a licensed band (e.g., LAA). Operations in unlicensed spectrum may include downlink transmissions, uplink transmissions, peer-to-peer transmissions, or a combination of these. Duplexing in unlicensed spectrum may be based on frequency division duplexing (FDD), time division duplexing (TDD), or a combination of both.

In some examples, base station 105 or UE 115 may be equipped with multiple antennas, which may be used to employ techniques such as transmit diversity, receive diversity, multiple-input multiple-output (MIMO) communications, or beamforming. For example, wireless communications system 100 may use a transmission scheme between a transmitting device (e.g., a base station 105) and a receiving device (e.g., a UE 115), where the transmitting device is equipped with multiple antennas and the receiving devices are equipped with one or more antennas. MIMO communications may employ multipath signal propagation to increase the spectral efficiency by transmitting or receiving multiple signals via different spatial layers, which may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream, and may carry bits associated with the same data stream (e.g., the same codeword) or different data streams. Different spatial layers may be associated with different antenna ports used for channel measurement and reporting. MIMO techniques include single-user MIMO (SU-MIMO) where multiple spatial layers are transmitted to the same receiving device, and multiple-user MIMO (MU-MIMO) where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105 or a UE 115) to shape or steer an antenna beam (e.g., a transmit beam or receive beam) along a spatial path between the transmitting device and the receiving device. Beamforming may be achieved by combining the signals communicated via antenna elements of an antenna array such that signals propagating at particular orientations with respect to an antenna array experience constructive interference while others experience destructive interference. The adjustment of signals communicated via the antenna elements may include a transmitting device or a receiving device applying certain amplitude and phase offsets to signals carried via each of the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In one example, a base station 105 may use multiple antennas or antenna arrays to conduct beamforming operations for directional communications with a UE 115. For instance, some signals (e.g. synchronization signals, reference signals, beam selection signals, or other control signals) may be transmitted by a base station 105 multiple times in different directions, which may include a signal being transmitted according to different beamforming weight sets associated with different directions of transmission. Transmissions in different beam directions may be used to identify (e.g., by the base station 105 or a receiving device, such as a UE 115) a beam direction for subsequent transmission and/or reception of communications by the UE 115 and the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based at least in in part on a signal transmitted in different beam directions. For example, a UE 115 may receive one or more signals transmitted by the base station 105 in different directions, and the UE 115 may report to the base station 105 an indication of the signal received by the UE 115 with a highest signal quality, or an otherwise acceptable signal quality. Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115), or transmitting a signal in a single direction (e.g., for transmitting data to a receiving device).

A receiving device (e.g., a UE 115, which may be an example of a mmW receiving device) may test multiple receive beams when receiving various signals from the base station 105, (e.g., synchronization signals, reference signals, beam selection signals, or other control signals). For example, a receiving device may test multiple receive directions by receiving via different antenna subarrays, by processing received signals according to different antenna subarrays, or by receiving or processing according to different receive beamforming weight sets applied to signals received at a plurality of antenna elements of an antenna array, any of which may be referred to as “listening” according to different receive beams or receive directions. In some examples a receiving device may use a single receive beam to receive along a single beam direction (e.g., when receiving a data signal). The single receive beam may be aligned in a beam direction determined based on listening to different receive beam directions (e.g., a beam direction determined to have a highest signal strength, highest signal-to-noise ratio, or otherwise acceptable signal quality based on listening to multiple beam directions).

In some cases, the antennas of a base station 105 or UE 115 may be located within one or more antenna arrays, which may support MIMO operations, or transmit or receive beamforming. For example, one or more base station antennas or antenna arrays may be co-located at an antenna assembly, such as an antenna tower. In some cases, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations.

In some cases, wireless communications system 100 may be a packet-based network that operate according to a layered protocol stack. In the user plane, communications at the bearer or Packet Data Convergence Protocol (PDCP) layer may be IP-based. A Radio Link Control (RLC) layer may in some cases perform packet segmentation and reassembly to communicate over logical channels. A Medium Access Control (MAC) layer may perform priority handling and multiplexing of logical channels into transport channels. The MAC layer may also use hybrid automatic repeat request (HARD) to provide retransmission at the MAC layer to improve link efficiency. In the control plane, the Radio Resource Control (RRC) protocol layer may provide establishment, configuration, and maintenance of an RRC connection between a UE 115 and a base station 105 or core network 130 supporting radio bearers for user plane data. At the Physical (PHY) layer, transport channels may be mapped to physical channels.

In some cases, UEs 115 and base stations 105 may support retransmissions of data to increase the likelihood that data is received successfully. HARQ feedback is one technique of increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., signal-to-noise conditions). In some cases, a wireless device may support same-slot HARQ feedback, where the device may provide HARQ feedback in a specific slot for data received in a previous symbol in the slot. In other cases, the device may provide HARQ feedback in a subsequent slot, or according to some other time interval.

Time intervals in LTE or NR may be expressed in multiples of a basic time unit, which may, for example, refer to a sampling period of Tₛ=1/30,720,000 seconds. Time intervals of a communications resource may be organized according to radio frames each having a duration of 10 milliseconds (ms), where the frame period may be expressed as Tₛ=307,200 Tₛ. The radio frames may be identified by a system frame number (SFN) ranging from 0 to 1023. Each frame may include 10 subframes numbered from 0 to 9, and each subframe may have a duration of 1 ms. A subframe may be further divided into 2 slots each having a duration of 0.5 ms, and each slot may contain 6 or 7 modulation symbol periods (e.g., depending on the length of the cyclic prefix prepended to each symbol period). Excluding the cyclic prefix, each symbol period may contain 2048 sampling periods. In some cases, a subframe may be the smallest scheduling unit of the wireless communications system 100, and may be referred to as a transmission time interval (TTI). In other cases, a smallest scheduling unit of the wireless communications system 100 may be shorter than a subframe or may be dynamically selected (e.g., in bursts of shortened TTIs (sTTIs) or in selected component carriers using sTTIs).

In some wireless communications systems, a slot may further be divided into multiple mini-slots containing one or more symbols. In some instances, a symbol of a mini-slot or a mini-slot may be the smallest unit of scheduling. Each symbol may vary in duration depending on the subcarrier spacing or frequency band of operation, for example. Further, some wireless communications systems may implement slot aggregation in which multiple slots or mini-slots are aggregated together and used for communication between a UE 115 and a base station 105.

The term “carrier” refers to a set of radio frequency spectrum resources having a defined physical layer structure for supporting communications over a communication link 125. For example, a carrier of a communication link 125 may include a portion of a radio frequency spectrum band that is operated according to physical layer channels for a given radio access technology. Each physical layer channel may carry user data, control information, or other signaling. A carrier may be associated with a pre-defined frequency channel (e.g., an E-UTRA absolute radio frequency channel number (EARFCN)), and may be positioned according to a channel raster for discovery by UEs 115. Carriers may be downlink or uplink (e.g., in an FDD mode), or be configured to carry downlink and uplink communications (e.g., in a TDD mode). In some examples, signal waveforms transmitted over a carrier may be made up of multiple sub-carriers (e.g., using multi-carrier modulation (MCM) techniques such as orthogonal frequency division multiplexing (OFDM) or DFT-s-OFDM).

The organizational structure of the carriers may be different for different radio access technologies (e.g., LTE, LTE-A, LTE-A Pro, NR, etc.). For example, communications over a carrier may be organized according to TTIs or slots, each of which may include user data as well as control information or signaling to support decoding the user data. A carrier may also include dedicated acquisition signaling (e.g., synchronization signals or system information, etc.) and control signaling that coordinates operation for the carrier. In some examples (e.g., in a carrier aggregation configuration), a carrier may also have acquisition signaling or control signaling that coordinates operations for other carriers.

Physical channels may be multiplexed on a carrier according to various techniques. A physical control channel and a physical data channel may be multiplexed on a downlink carrier, for example, using time division multiplexing (TDM) techniques, frequency division multiplexing (FDM) techniques, or hybrid TDM-FDM techniques. In some examples, control information transmitted in a physical control channel may be distributed between different control regions in a cascaded manner (e.g., between a common control region or common search space and one or more UE-specific control regions or UE-specific search spaces).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of predetermined bandwidths for carriers of a particular radio access technology (e.g., 1.4, 3, 5, 10, 15, 20, 40, or 80 MHz). In some examples, each served UE 115 may be configured for operating over portions or all of the carrier bandwidth. In other examples, some UEs 115 may be configured for operation using a narrowband protocol type that is associated with a predefined portion or range (e.g., set of subcarriers or RBs) within a carrier (e.g., “in-band” deployment of a narrowband protocol type).

In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme). Thus, the more resource elements that a UE 115 receives and the higher the order of the modulation scheme, the higher the data rate may be for the UE 115. In MIMO systems, a wireless communications resource may refer to a combination of a radio frequency spectrum resource, a time resource, and a spatial resource (e.g., spatial layers), and the use of multiple spatial layers may further increase the data rate for communications with a UE 115.

Devices of the wireless communications system 100 (e.g., base stations 105 or UEs 115) may have a hardware configuration that supports communications over a particular carrier bandwidth, or may be configurable to support communications over one of a set of carrier bandwidths. In some examples, the wireless communications system 100 may include base stations 105 and/or UEs 115 that can support simultaneous communications via carriers associated with more than one different carrier bandwidth.

Wireless communications system 100 may support communication with a UE 115 on multiple cells or carriers, a feature which may be referred to as carrier aggregation (CA) or multi-carrier operation. A UE 115 may be configured with multiple downlink CCs and one or more uplink CCs according to a carrier aggregation configuration. Carrier aggregation may be used with both FDD and TDD component carriers.

In some cases, wireless communications system 100 may utilize enhanced component carriers (eCCs). An eCC may be characterized by one or more features including wider carrier or frequency channel bandwidth, shorter symbol duration, shorter TTI duration, or modified control channel configuration. In some cases, an eCC may be associated with a carrier aggregation configuration or a dual connectivity configuration (e.g., when multiple serving cells have a suboptimal or non-ideal backhaul link). An eCC may also be configured for use in unlicensed spectrum or shared spectrum (e.g., where more than one operator is allowed to use the spectrum). An eCC characterized by wide carrier bandwidth may include one or more segments that may be utilized by UEs 115 that are not capable of monitoring the whole carrier bandwidth or are otherwise configured to use a limited carrier bandwidth (e.g., to conserve power).

In some cases, an eCC may utilize a different symbol duration than other CCs, which may include use of a reduced symbol duration as compared with symbol durations of the other CCs. A shorter symbol duration may be associated with increased spacing between adjacent subcarriers. A device, such as a UE 115 or base station 105, utilizing eCCs may transmit wideband signals (e.g., according to frequency channel or carrier bandwidths of 20, 40, 60, 80 MHz, etc.) at reduced symbol durations (e.g., 16.67 microseconds). A TTI in eCC may consist of one or multiple symbol periods. In some cases, the TTI duration (that is, the number of symbol periods in a TTI) may be variable.

Wireless communications systems such as an NR system may utilize any combination of licensed, shared, and unlicensed spectrum bands, among others. The flexibility of eCC symbol duration and subcarrier spacing may allow for the use of eCC across multiple spectrums. In some examples, NR shared spectrum may increase spectrum utilization and spectral efficiency, specifically through dynamic vertical (e.g., across the frequency domain) and horizontal (e.g., across the time domain) sharing of resources.

In some cases, a UE 115 and base station 105 (e.g., or two UEs 115) may communicate in a DRX mode. For example, DRX mode may be used to extend a battery life of one or both communicating devices, to support periodic communications, to reduce communication congestion in wireless communications system 100, etc. DRX mode operation may include alternating periods of activity and inactivity for one or both communicating devices. By way of example, a UE 115 operating in DRX mode may periodically inactivate one or more receive chains (e.g., or tune such receive chains to other frequencies or communication channels) that support communications with a base station 105 (e.g., or with another UE 115) during DRX active durations.

Some devices may support beam management procedures (e.g., in support of the beamforming operations discussed herein). For example, beam management may include BFD, which may be based on one or more communication metrics associated with a given beam (e.g., reference signal quality metrics). When the reference signal quality metrics fail to satisfy a threshold (e.g., a configurable threshold, a dynamically selected threshold, a static threshold), a beam failure event may be detected. The beam failure detection event may result in incrementing a counter, resetting a timer, or other such beam failure tracking operations (e.g., as described further below).

In accordance with aspects of the present disclosure, the UE 115 may restrict BFD to DRX active period durations (e.g., may coordinate beam management operations with a DRX schedule). For example, the UE 115 may perform BFD during DRX active durations, may run a beam failure timer during the DRX active durations, or the like. Correspondingly, the UE 115 may not perform BFD during DRX inactive durations (e.g., may not monitor reference signal quality metrics during DRX inactive durations).

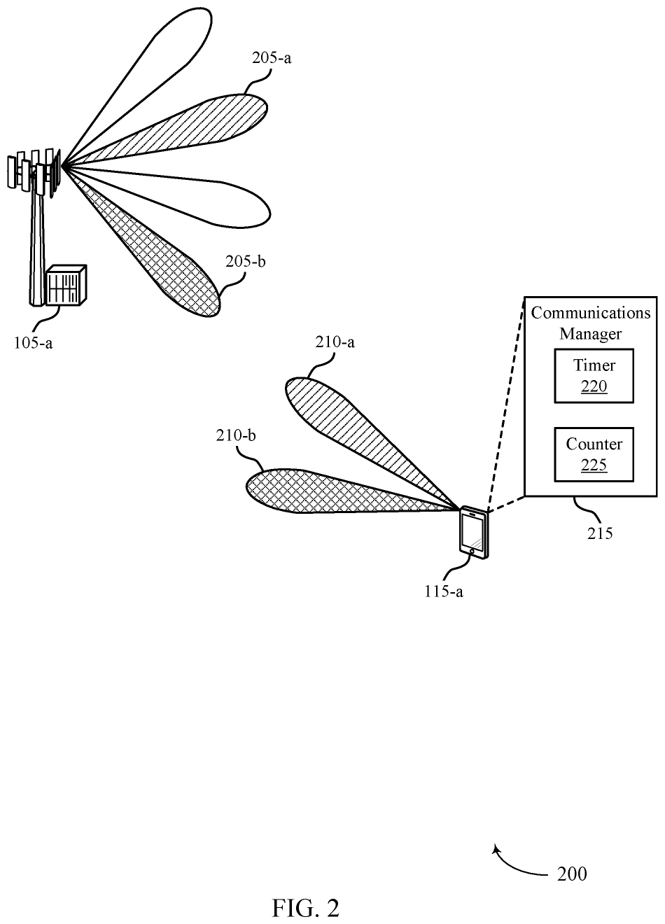

FIG. 2 illustrates an example of a wireless communications system 200 that supports BFD procedures in DRX mode in accordance with aspects of the present disclosure. In some examples, wireless communications system 200 may implement aspects of wireless communication system 100. For example, wireless communications system 200 may include a base station 105-a and UE 115-a, each of which may be an example of the corresponding devices described above. Although illustrated and described in the context of a base station 105 communicating with a UE 115, it is to be understood that aspects of the present disclosure may additionally or alternatively apply to communications between UEs 115 (e.g., between a mobile device and a sensor or the like).

Wireless communications system 200 may support beamformed communications. For example, wireless communications system 200 may operate in a frequency range where beamforming may be used to accommodate frequency-dependent signal attenuation (e.g., mmW frequencies). Additionally or alternatively, wireless communications system 200 may operate in frequency ranges (e.g., sub-6 GHz frequency ranges) where beamforming is not employed to alleviate signal attenuation (e.g., but may still utilize beamforming).

Base station 105-a and UE 115-a may perform (e.g., independently or in conjunction) beam management procedures which may allow for suitable beams to be identified and monitored. For example, base station 105-a may transmit reference signals across multiple transmit beams 205 (e.g., where each transmit beam 205 may refer to a given combination of signals transmitted from respective antenna elements or arrays). Similarly, UE 115-a may receive these reference signals across one or more receive beams 210 (e.g., where each receive beam 210 refers to a combination of the signals received across different antenna elements or arrays).

In some cases, communications between base station 105-a and UE 115-a may be referred to as occurring over one or more beam pairs (e.g., where each beam pair includes a respective transmit beam 205 and receive beam 210). In the present example, base station 105-a and UE 115-a may communicate (e.g., simultaneously or otherwise) over a first beam pair that includes transmit beam 205-a and receive beam 210-a and a second beam pair that includes transmit beam 205-b and receive beam 210-b. In other examples, more (or fewer) beam pairs may be supported, and a given transmit beam 205 (or receive beam 210) may be common to one or more beam pairs.

Aspects of the present disclosure relate to techniques for monitoring beam pairs in accordance with DRX mode operation. For example, UE 115-a may include a communications manager 215 (e.g., which may be an example of the corresponding component described below), and communications manager 215 may in turn include a timer 220 and counter 225 (e.g., or analogous digital components). During BFD procedures, UE 115-a may identify that a beam failure event has occurred if the reference signal quality for one (e.g., or all) of the beam pairs falls below a threshold value. In such cases, a PHY layer may send a failure indication to a MAC layer, and the MAC layer may increment counter 225 by one (e.g., or by a number of beam pairs having reference signal quality below the threshold value). If counter 225 exceeds a value (e.g., a configurable value, a static value, or the like), beam recovery may be performed (e.g., which may result in the identification of one or more beam pairs where reference signal quality is above the threshold value). Timer 220 may begin counting down from an initial value (e.g., from a configurable value, a static value, or the like) upon indication of the beam failure event. Each beam failure event may reset timer 220 to the initial value. Expiration of timer 220 may lead to counter 225 being reset (e.g., to 0).

In some aspects, UE 115-a may monitor reference signals (e.g., which may be referred to as BFD reference signals) associated with the first beam pair (and/or second beam pair) during an active DRX duration (e.g., but may refrain from monitoring such reference signals during inactive DRX durations). That is, UE 115-a may not perform radio link quality measurement during DRX inactive durations (e.g., to improve power saving or in consideration of other such benefits). If the DRX periodicity is short (e.g., if DRX active durations occur frequently), link quality measurements may be performed with the same periodicity as that of BFD reference signals or with a periodicity comparable to the expected coherence time of BFD reference signal beams. For longer DRX periodicities, monitoring beams during DRX inactive durations may not benefit UE 115-a. Thus, in accordance with aspects of the present disclosure a device operating in DRX mode for radio link monitoring procedures may assess link quality once per indication period, where the indication period may be the larger of the shortest periodicity for BFD reference signals and the DRX periodicity. That is, the link quality may be measured (e.g., at most) once per DRX period.

Additionally, UE 115-a may stop timer 220 during DRX inactive durations. For example, timer 220 may otherwise run continuously until expiring, or until a beam failure indication is received from the PHY layer. Because a device operating in accordance with aspects of the present disclosure may not measure radio link quality during DRX inactive durations, no beam failure indications would be received. If the DRX period is longer than the duration of timer 220, timer 220 may expire before the next DRX active duration. Because expiration of timer 220 results in counter 225 being reset, such a scenario may result in beam failure (e.g., and beam reselection) never being triggered (e.g., because counter 225 is reset each DRX active duration). In cases in which the duration of timer 220 is longer than the DRX period, the DRX inactive periods still impact the efficacy of timer 220 (e.g., potentially resulting in counter 225 being reset too early and UE 115-a being less reactive to beam failures). As such, UE 115-a may stop timer 220 during all DRX inactive durations.

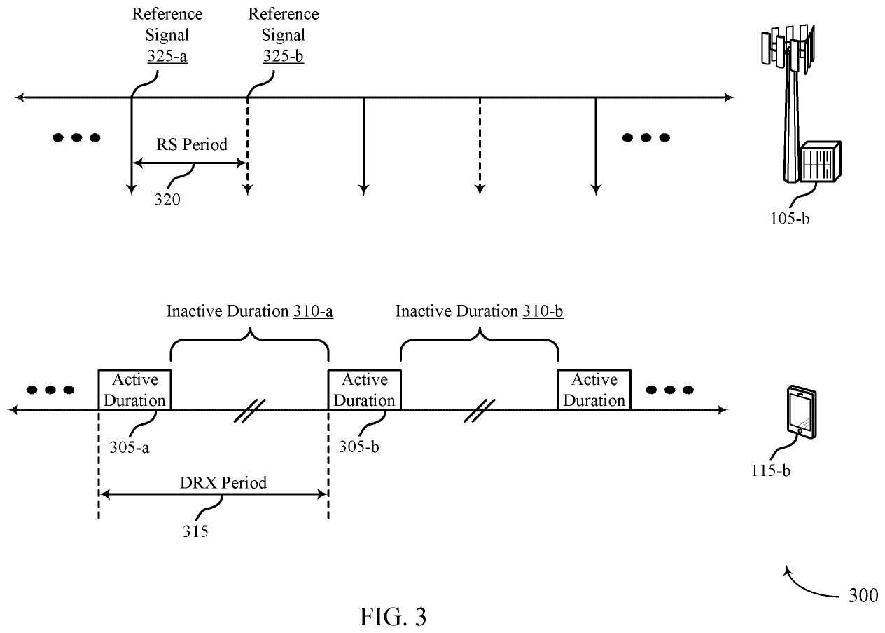

FIG. 3 illustrates an example of a timing diagram 300 that supports BFD procedures in DRX mode in accordance with aspects of the present disclosure. In some examples timing diagram 300 may implement aspects of wireless communication systems 100 or 200. For example, timing diagram 300 may include a UE 115-b and base station 105-b, each of which may be an example of the corresponding devices described with reference to FIGS. 1 and 2.

UE 115-b may operate in DRX mode in accordance with aspects of the present disclosure. For example, the DRX mode may include DRX periods 315, each of which may include an active duration 305 and an inactive duration 310. It is to be understood that aspects of timing diagram 300 are included for the sake of explanation and may not be drawn to scale (e.g., active duration 305 may in some cases be longer than inactive duration 310, active duration 305-a may in some cases be different from active duration 305-b, inactive duration 310-a may be different from inactive duration 310-b, or the like).

Base station 105-b may in some cases transmit reference signals 325 (e.g., over one or more beams) in support of beam management procedures (e.g., BFD). For example, a first reference signal 325-a and a second reference signal 325-b may be separated in time by reference signal period 320. In some cases, reference signal period 320 may be based on DRX period 315 (e.g., or vice-versa such that the periods may in some cases be coordinated). As illustrated, reference signal 325-a may be scheduled to transmit during active duration 305-a while reference signal 325-b may be scheduled to transmit during inactive duration 310-a. In accordance with aspects of the present disclosure, UE 115-b may refrain from performing radio link quality measurements based on reference signal 325-b. That is, UE 115-b may restrict radio link quality measurements to reference signals received during active durations 305 (e.g., reference signal 325-a). In some examples, UE 115-b may perform one radio link quality measurement per monitored beam during each DRX period 315.

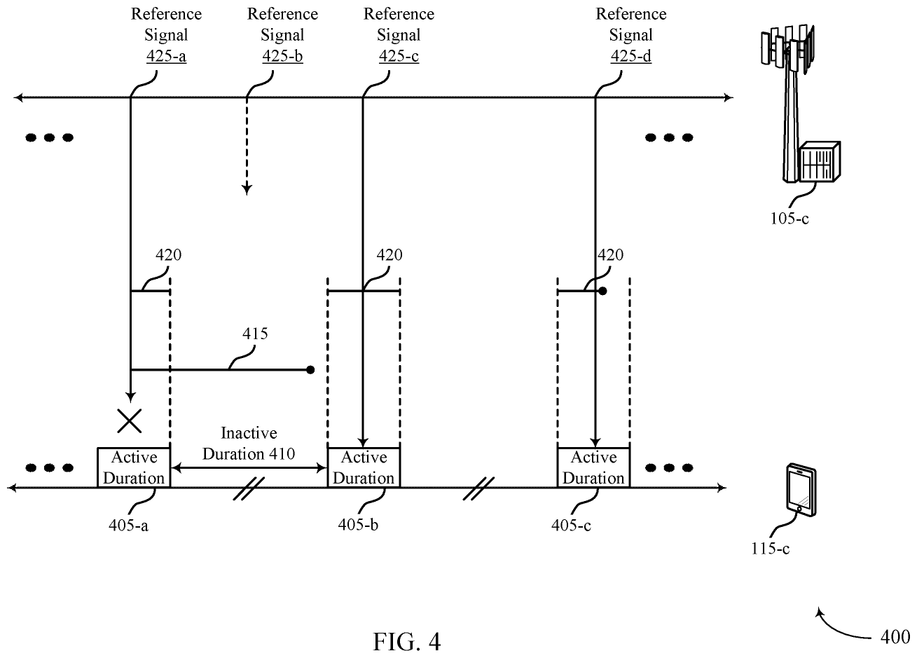

FIG. 4 illustrates an example of a timing diagram 400 that supports BFD procedures in DRX mode in accordance with aspects of the present disclosure. In some examples, timing diagram 400 may implement aspects of wireless communication systems 100 or 200. For example, timing diagram 400 may include a UE 115-c and base station 105-c, each of which may be an example of the corresponding devices described with reference to FIGS. 1 and 2.

UE 115-c may operate in DRX mode in accordance with aspects of the present disclosure. For example, the DRX mode may include DRX periods, each of which may include an active duration 405 and an inactive duration 410 (e.g., as described with reference to FIG. 3). It is to be understood that aspects of timing diagram 400 are included for the sake of explanation and may not be drawn to scale (e.g., active duration 405 may in some cases be longer than inactive duration 410, active duration 405-a may in some cases be different from active duration 405-b, or the like).

Base station 105-c may in some cases transmit reference signals 425 (e.g., over one or more beams) in support of beam management procedures (e.g., BFD). In some cases, transmission of reference signals 425 may be coordinated with the DRX mode operation. For example, base station 105-c may transmit reference signal 425-a during active duration 405-a. In the present example, UE 115-c may not receive reference signal 425-a with sufficient quality to satisfy a beam monitoring threshold (e.g., the reference signal received power (RSRP) of reference signal 425-a may fall below the threshold, or the like). As described with reference to FIG. 2, UE 115-c may increment a counter based on the detected beam failure event and may start a beam failure timer.

In accordance with aspects of the present disclosure, the beam failure timer may support DRX operations. For example, without the described techniques, the beam failure timer may expire as illustrated by timer duration 415. That is, the timer may expire during inactive duration 410 (e.g., because UE 115-c may not monitor for reference signal 425-b during inactive duration 410). Expiration of the beam failure timer may result in the counter being reset and may inhibit UE 115-c from properly triggering a beam recovery process. In accordance with the described techniques, the beam failure timer may be operated according to timer duration 420. That is, the beam failure timer may be stopped when the UE 115-c enters inactive durations 410 (e.g., to accommodate for the fact that UE 115-c may not monitor for reference signals 425 during inactive durations 410).

UE 115-c may, for example, stop the timer at the end of active duration 405-a, may continue the timer at the beginning of active duration 405-b, and may successfully receive reference signal 425-c during active duration 405-b. Similarly, UE 115-c may stop the timer at the end of active duration 405-b, may continue the timer at the beginning of active duration 405-c, and may successfully receive reference signal 425-d during active duration 405-c, resulting in the beam failure timer expiring after timer duration 420 (e.g., and the beam failure counter being reset). Alternatively, if a beam failure event occurs for reference signal 425-c (e.g., or reference signal 425-d), the beam failure timer may be reset (e.g., and timer duration 420 may effectively commence following the most recent beam failure event).

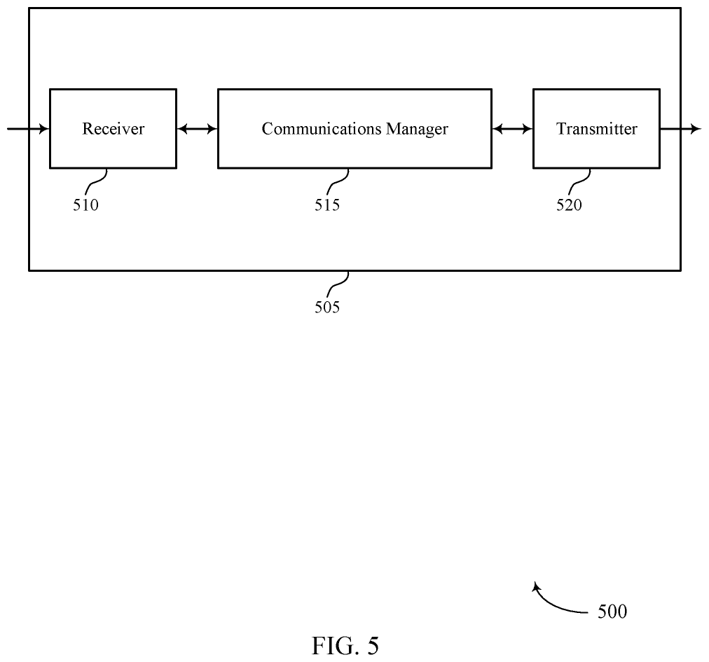

FIG. 5 shows a block diagram 500 of a device 505 that supports BFD procedures in DRX mode in accordance with aspects of the present disclosure. The device 505 may be an example of aspects of a UE 115 as described herein. The device 505 may include a receiver 510, a communications manager 515, and a transmitter 520. The device 505 may also include a processor. Each of these components may be in communication with one another (e.g., via one or more buses).

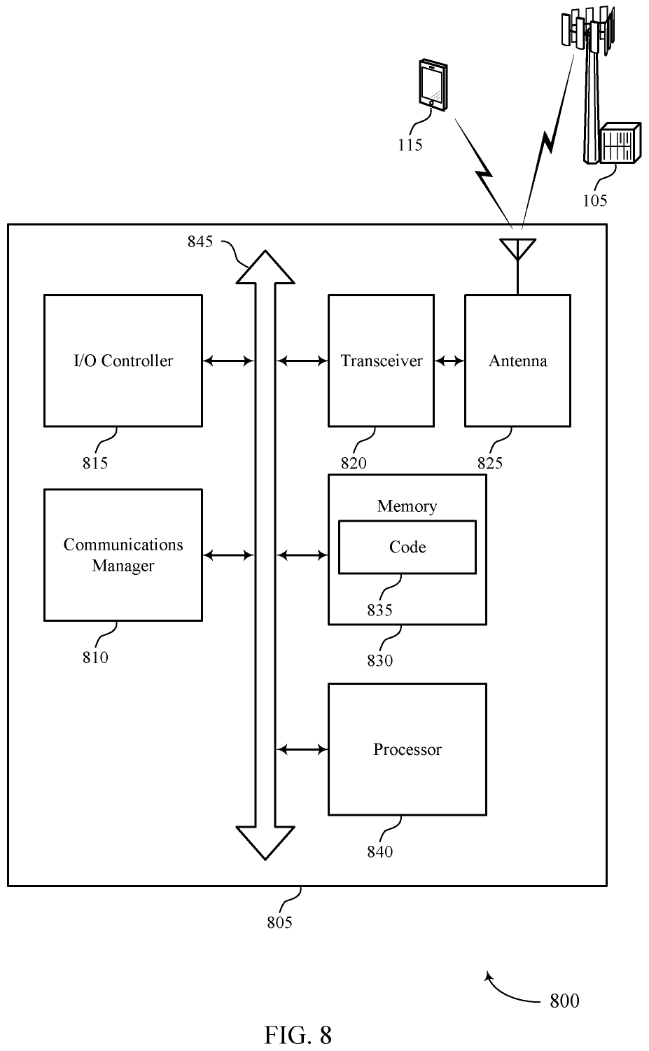

The receiver 510 may receive information such as packets, user data, or control information associated with various information channels (e.g., control channels, data channels, and information related to beam failure detection procedures in DRX mode, etc.). Information may be passed on to other components of the device 505. The receiver 510 may be an example of aspects of the transceiver 820 described with reference to FIG. 8. The receiver 510 may utilize a single antenna or a set of antennas.

The communications manager 515 may identify that the UE is configured to operate in a DRX mode, where each DRX period includes an active duration and an inactive duration. The communications manager 515 may identify that the UE is configured to perform a BFD procedure. The communications manager 515 may monitor for beam failure in accordance with the BFD procedure during (e.g., only during) the active duration of the DRX period. The communications manager 515 may be an example of aspects of the communications manager 810 described herein.

The communications manager 515, or its sub-components, may be implemented in hardware, code (e.g., software or firmware) executed by a processor, or any combination thereof. If implemented in code executed by a processor, the functions of the communications manager 515, or its sub-components may be executed by a general-purpose processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described in the present disclosure.

The communications manager 515, or its sub-components, may be physically located at various positions, including being distributed such that portions of functions are implemented at different physical locations by one or more physical components. In some examples, the communications manager 515, or its sub-components, may be a separate and distinct component in accordance with various aspects of the present disclosure. In some examples, the communications manager 515, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The transmitter 520 may transmit signals generated by other components of the device 505. In some examples, the transmitter 520 may be collocated with a receiver 510 in a transceiver module. For example, the transmitter 520 may be an example of aspects of the transceiver 820 described with reference to FIG. 8. The transmitter 520 may utilize a single antenna or a set of antennas.

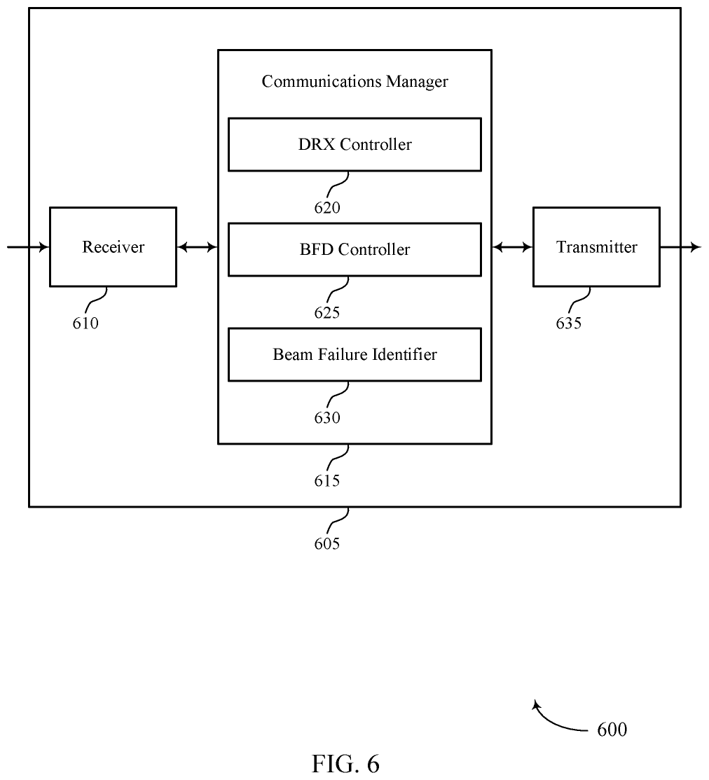

FIG. 6 shows a block diagram 600 of a device 605 that supports BFD procedures in DRX mode in accordance with aspects of the present disclosure. The device 605 may be an example of aspects of a device 505 or a UE 115 as described herein. The device 605 may include a receiver 610, a communications manager 615, and a transmitter 635. The device 605 may also include a processor. Each of these components may be in communication with one another (e.g., via one or more buses).

The receiver 610 may receive information such as packets, user data, or control information associated with various information channels (e.g., control channels, data channels, and information related to BFD procedures in DRX mode, etc.). Information may be passed on to other components of the device 605. The receiver 610 may be an example of aspects of the transceiver 820 described with reference to FIG. 8. The receiver 610 may utilize a single antenna or a set of antennas.

The communications manager 615 may be an example of aspects of the communications manager 515 as described herein. The communications manager 615 may include a DRX controller 620, a BFD controller 625, and a beam failure identifier 630. The communications manager 615 may be an example of aspects of the communications manager 810 described herein.

The DRX controller 620 may identify that the UE is configured to operate in a DRX mode, where each DRX period includes an active duration and an inactive duration. The BFD controller 625 may identify that the UE is configured to perform a BFD procedure. The beam failure identifier 630 may monitor for beam failure in accordance with the BFD procedure during (e.g., only during) the active duration of the DRX period.

The transmitter 635 may transmit signals generated by other components of the device 605. In some examples, the transmitter 635 may be collocated with a receiver 610 in a transceiver module. For example, the transmitter 635 may be an example of aspects of the transceiver 820 described with reference to FIG. 8. The transmitter 635 may utilize a single antenna or a set of antennas.

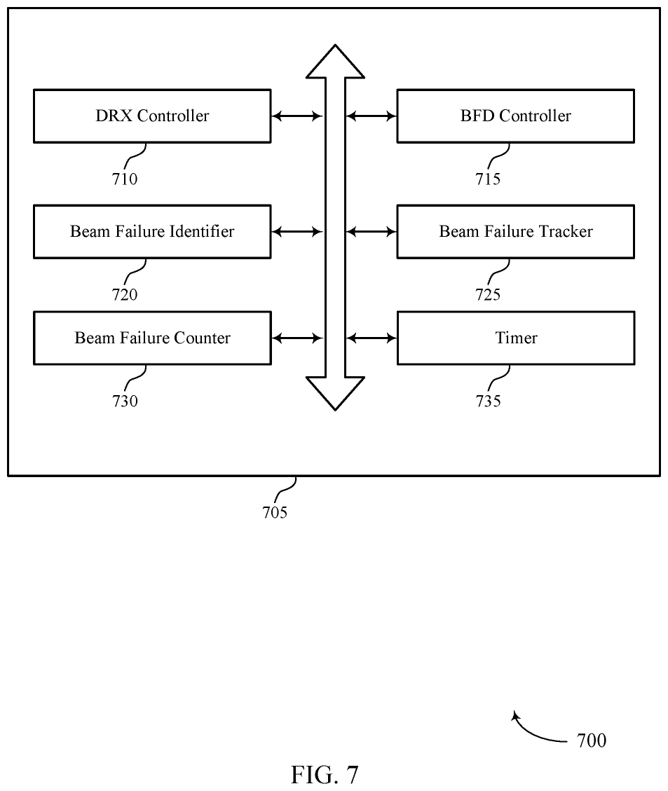

FIG. 7 shows a block diagram 700 of a communications manager 705 that supports BFD procedures in DRX mode in accordance with aspects of the present disclosure. The communications manager 705 may be an example of aspects of a communications manager 515, a communications manager 615, or a communications manager 810 described herein. The communications manager 705 may include a DRX controller 710, a BFD controller 715, a beam failure identifier 720, a beam failure tracker 725, a beam failure counter 730, and a timer 735. Each of these modules may communicate, directly or indirectly, with one another (e.g., via one or more buses).

The DRX controller 710 may identify that the UE is configured to operate in a DRX mode, where each DRX period includes an active duration and an inactive duration. The BFD controller 715 may identify that the UE is configured to perform a BFD procedure. In some examples, the BFD controller 715 may receive an indication that the UE is to perform the BFD procedure during (e.g., only during) the active duration of the DRX period.

The beam failure identifier 720 may monitor for beam failure in accordance with the BFD procedure during (e.g., only during) the active duration of the DRX period. In some examples, the beam failure identifier 720 may monitor for beam failure based on the UE entering the active duration of the DRX period. In some examples, the beam failure identifier 720 may monitor one or more reference signals associated with BFD, where the monitoring is based on a periodicity of transmission of the one or more reference signals. In some examples, the beam failure identifier 720 may perform link quality measurements based on the one or more reference signals with a same periodicity as the periodicity of transmission of the one or more reference signals. In some examples, the beam failure identifier 720 may monitor one or more beams associated with BFD reference signals, where the monitoring is based on a periodicity of an expected coherence time of the one or more beams. In some examples, the beam failure identifier 720 may monitor for beam failure in accordance with a periodicity, where the periodicity is based on (e.g., based on a maximum between) the DRX period and a shortest periodicity for transmission of BFD reference signals. In some examples, the beam failure identifier 720 may monitor for beam failure in accordance with a periodicity, where the periodicity is based on the DRX period.

The beam failure tracker 725 may operate timer 735 in accordance with the BFD procedure (e.g., during the active duration of the DRX period), where expiration of the timer 735 results in a beam failure counter 730 being reset. In some examples, the beam failure tracker 725 may stop the timer 735 based on the UE entering the inactive duration of the DRX period. In some examples, the beam failure tracker 725 may receive an indication that the UE is to operate a timer 735 associated with the BFD procedure during (e.g., only during) the active duration of the DRX period, where expiration of the timer 735 results in a beam failure counter 730 being reset. In some examples, the beam failure tracker 725 may refrain from resetting a beam failure counter during the inactive duration of the DRX period.

FIG. 8 shows a diagram of a system 800 including a device 805 that supports BFD procedures in DRX mode in accordance with aspects of the present disclosure. The device 805 may be an example of or include the components of device 505, device 605, or a UE 115 as described herein. The device 805 may include components for bi-directional voice and data communications including components for transmitting and receiving communications, including a communications manager 810, an I/O controller 815, a transceiver 820, an antenna 825, memory 830, and a processor 840. These components may be in electronic communication via one or more buses (e.g., bus 845).

The communications manager 810 may identify that the UE is configured to operate in a DRX mode, where each DRX period includes an active duration and an inactive duration. The communications manager 810 may identify that the UE is configured to perform a BFD procedure. The communications manager 810 may monitor for beam failure in accordance with the BFD procedure during (e.g., only during) the active duration of the DRX period.

The I/O controller 815 may manage input and output signals for the device 805. The I/O controller 815 may also manage peripherals not integrated into the device 805. In some cases, the I/O controller 815 may represent a physical connection or port to an external peripheral. In some cases, the I/O controller 815 may utilize an operating system such as iOS®, ANDROID®, MS-DOS®, MS-WINDOWS®, OS/2®, UNIX®, LINUX®, or another known operating system. In other cases, the I/O controller 815 may represent or interact with a modem, a keyboard, a mouse, a touchscreen, or a similar device. In some cases, the I/O controller 815 may be implemented as part of a processor. In some cases, a user may interact with the device 805 via the I/O controller 815 or via hardware components controlled by the I/O controller 815.

The transceiver 820 may communicate bi-directionally, via one or more antennas, wired, or wireless links as described above. For example, the transceiver 820 may represent a wireless transceiver and may communicate bi-directionally with another wireless transceiver. The transceiver 820 may also include a modem to modulate the packets and provide the modulated packets to the antennas for transmission, and to demodulate packets received from the antennas. In some cases, the wireless device may include a single antenna 825. However, in some cases the device may have more than one antenna 825, which may be capable of concurrently transmitting or receiving multiple wireless transmissions.

The memory 830 may include random access memory (RAM) and read only memory (ROM). The memory 830 may store computer-readable, computer-executable code 835 including instructions that, when executed, cause the processor to perform various functions described herein. In some cases, the memory 830 may contain, among other things, a basic I/O system (BIOS) which may control basic hardware or software operation such as the interaction with peripheral components or devices.

The processor 840 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In other cases, a memory controller may be integrated into the processor 840. The processor 840 may be configured to execute computer-readable instructions stored in a memory (e.g., the memory 830) to cause the device 805 to perform various functions (e.g., functions or tasks supporting beam failure detection procedures in DRX mode).

The code 835 may include instructions to implement aspects of the present disclosure, including instructions to support wireless communications. The code 835 may be stored in a non-transitory computer-readable medium such as system memory or other type of memory. In some cases, the code 835 may not be directly executable by the processor 840 but may cause a computer (e.g., when compiled and executed) to perform functions described herein.

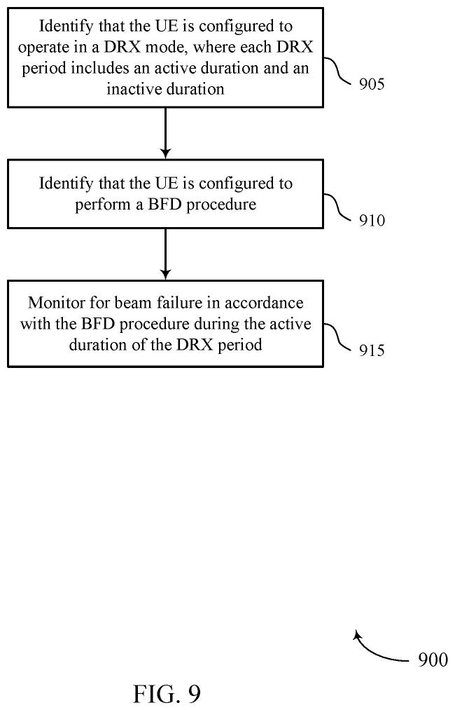

FIG. 9 shows a flowchart illustrating a method 900 that supports BFD procedures in DRX mode in accordance with aspects of the present disclosure. The operations of method 900 may be implemented by a UE 115 or its components as described herein. For example, the operations of method 900 may be performed by a communications manager as described with reference to FIGS. 5 through 8. In some examples, a UE may execute a set of instructions to control the functional elements of the UE to perform the functions described below. Additionally or alternatively, a UE may perform aspects of the functions described below using special-purpose hardware.

At 905, the UE may identify that it is configured to operate in a DRX mode, where each DRX period includes an active duration and an inactive duration. The operations of 905 may be performed according to the methods described herein. In some examples, aspects of the operations of 905 may be performed by a DRX controller as described with reference to FIGS. 5 through 8.

At 910, the UE may identify that it is configured to perform a BFD procedure. The operations of 910 may be performed according to the methods described herein. In some examples, aspects of the operations of 910 may be performed by a BFD controller as described with reference to FIGS. 5 through 8.

At 915, the UE may monitor for beam failure in accordance with the BFD procedure during (e.g., only during) the active duration of the DRX period. The operations of 915 may be performed according to the methods described herein. In some examples, aspects of the operations of 915 may be performed by a beam failure identifier as described with reference to FIGS. 5 through 8.

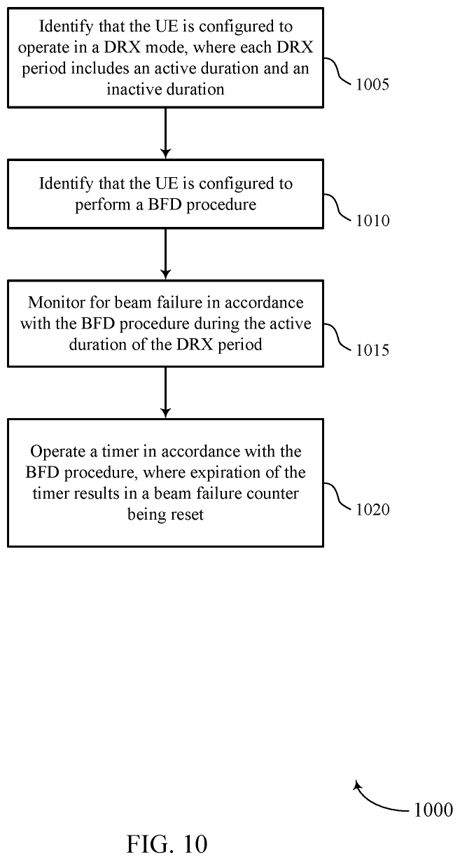

FIG. 10 shows a flowchart illustrating a method 1000 that supports BFD procedures in DRX mode in accordance with aspects of the present disclosure. The operations of method 1000 may be implemented by a UE 115 or its components as described herein. For example, the operations of method 1000 may be performed by a communications manager as described with reference to FIGS. 5 through 8. In some examples, a UE may execute a set of instructions to control the functional elements of the UE to perform the functions described below. Additionally or alternatively, a UE may perform aspects of the functions described below using special-purpose hardware.

At 1005, the UE may identify that it is configured to operate in a DRX mode, where each DRX period includes an active duration and an inactive duration. The operations of 1005 may be performed according to the methods described herein. In some examples, aspects of the operations of 1005 may be performed by a DRX controller as described with reference to FIGS. 5 through 8.

At 1010, the UE may identify that it is configured to perform a BFD procedure. The operations of 1010 may be performed according to the methods described herein. In some examples, aspects of the operations of 1010 may be performed by a BFD controller as described with reference to FIGS. 5 through 8.

At 1015, the UE may monitor for beam failure in accordance with the BFD procedure during (e.g., only during) the active duration of the DRX period. The operations of 1015 may be performed according to the methods described herein. In some examples, aspects of the operations of 1015 may be performed by a beam failure identifier as described with reference to FIGS. 5 through 8.

At 1020, the UE may operate a timer in accordance with the BFD procedure and during the active duration of the DRX period, where expiration of the timer results in a beam failure counter being reset. The operations of 1020 may be performed according to the methods described herein. In some examples, aspects of the operations of 1020 may be performed by a beam failure tracker as described with reference to FIGS. 5 through 8.

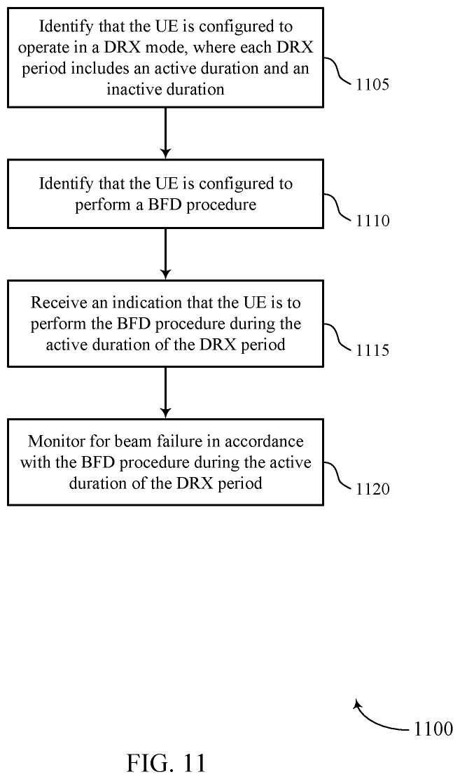

FIG. 11 shows a flowchart illustrating a method 1100 that supports BFD procedures in DRX mode in accordance with aspects of the present disclosure. The operations of method 1100 may be implemented by a UE 115 or its components as described herein. For example, the operations of method 1100 may be performed by a communications manager as described with reference to FIGS. 5 through 8. In some examples, a UE may execute a set of instructions to control the functional elements of the UE to perform the functions described below. Additionally or alternatively, a UE may perform aspects of the functions described below using special-purpose hardware.

At 1105, the UE may identify that it is configured to operate in a DRX mode, where each DRX period includes an active duration and an inactive duration. The operations of 1105 may be performed according to the methods described herein. In some examples, aspects of the operations of 1105 may be performed by a DRX controller as described with reference to FIGS. 5 through 8.

At 1110, the UE may identify that it is configured to perform a BFD procedure. The operations of 1110 may be performed according to the methods described herein. In some examples, aspects of the operations of 1110 may be performed by a BFD controller as described with reference to FIGS. 5 through 8.

At 1115, the UE may receive an indication that it is to perform the BFD procedure during (e.g., only during) the active duration of the DRX period. The operations of 1115 may be performed according to the methods described herein. In some examples, aspects of the operations of 1115 may be performed by a BFD controller as described with reference to FIGS. 5 through 8.

At 1120, the UE may monitor for beam failure in accordance with the BFD procedure during (e.g., only during) the active duration of the DRX period. The operations of 1120 may be performed according to the methods described herein. In some examples, aspects of the operations of 1120 may be performed by a beam failure identifier as described with reference to FIGS. 5 through 8.

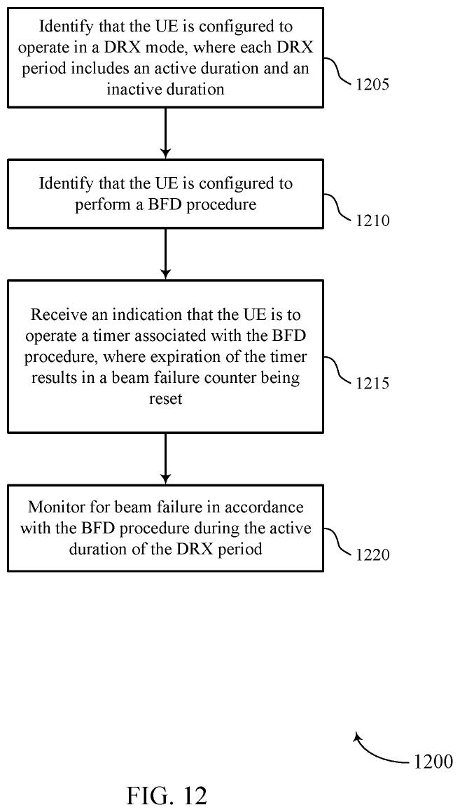

FIG. 12 shows a flowchart illustrating a method 1200 that supports BFD procedures in DRX mode in accordance with aspects of the present disclosure. The operations of method 1200 may be implemented by a UE 115 or its components as described herein. For example, the operations of method 1200 may be performed by a communications manager as described with reference to FIGS. 5 through 8. In some examples, a UE may execute a set of instructions to control the functional elements of the UE to perform the functions described below. Additionally or alternatively, a UE may perform aspects of the functions described below using special-purpose hardware.

At 1205, the UE may identify that the UE is configured to operate in a DRX mode, where each DRX period includes an active duration and an inactive duration. The operations of 1205 may be performed according to the methods described herein. In some examples, aspects of the operations of 1205 may be performed by a DRX controller as described with reference to FIGS. 5 through 8.

At 1210, the UE may identify that the UE is configured to perform a BFD procedure. The operations of 1210 may be performed according to the methods described herein. In some examples, aspects of the operations of 1210 may be performed by a BFD controller as described with reference to FIGS. 5 through 8.

At 1215, the UE may receive an indication that the UE is to operate a timer associated with the BFD procedure (e.g., only during the active duration of the DRX period), where expiration of the timer results in a beam failure counter being reset. The operations of 1215 may be performed according to the methods described herein. In some examples, aspects of the operations of 1215 may be performed by a beam failure tracker as described with reference to FIGS. 5 through 8.

At 1220, the UE may monitor for beam failure in accordance with the BFD procedure during (e.g., only during) the active duration of the DRX period. The operations of 1220 may be performed according to the methods described herein. In some examples, aspects of the operations of 1220 may be performed by a beam failure identifier as described with reference to FIGS. 5 through 8.

It should be noted that the methods described above describe possible implementations, and that the operations and the steps may be rearranged or otherwise modified and that other implementations are possible. Further, aspects from two or more of the methods may be combined.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. A CDMA system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1X, 1X, etc. IS-856 (TIA-856) is commonly referred to as CDMA2000 1xEV-DO, High Rate Packet Data (HRPD), etc. UTRA includes Wideband CDMA (WCDMA) and other variants of CDMA. A TDMA system may implement a radio technology such as Global System for Mobile Communications (GSM).

An OFDMA system may implement a radio technology such as Ultra Mobile Broadband (UMB), Evolved UTRA (E-UTRA), Institute of Electrical and Electronics Engineers (IEEE) 802.11 (Wi-Fi), IEEE 802.16 (WiMAX), IEEE 802.20, Flash-OFDM, etc. UTRA and E-UTRA are part of Universal Mobile Telecommunications System (UMTS). LTE, LTE-A, and LTE-A Pro are releases of UMTS that use E-UTRA. UTRA, E-UTRA, UMTS, LTE, LTE-A, LTE-A Pro, NR, and GSM are described in documents from the organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies. While aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR applications.

A macro cell generally covers a relatively large geographic area (e.g., several kilometers in radius) and may allow unrestricted access by UEs 115 with service subscriptions with the network provider. A small cell may be associated with a lower-powered base station 105, as compared with a macro cell, and a small cell may operate in the same or different (e.g., licensed, unlicensed, etc.) frequency bands as macro cells. Small cells may include pico cells, femto cells, and micro cells according to various examples. A pico cell, for example, may cover a small geographic area and may allow unrestricted access by UEs 115 with service subscriptions with the network provider. A femto cell may also cover a small geographic area (e.g., a home) and may provide restricted access by UEs 115 having an association with the femto cell (e.g., UEs 115 in a closed subscriber group (CSG), UEs 115 for users in the home, and the like). An eNB for a macro cell may be referred to as a macro eNB. An eNB for a small cell may be referred to as a small cell eNB, a pico eNB, a femto eNB, or a home eNB. An eNB may support one or multiple (e.g., two, three, four, and the like) cells, and may also support communications using one or multiple component carriers.

The wireless communications system 100 or systems described herein may support synchronous or asynchronous operation. For synchronous operation, the base stations 105 may have similar frame timing, and transmissions from different base stations 105 may be approximately aligned in time. For asynchronous operation, the base stations 105 may have different frame timing, and transmissions from different base stations 105 may not be aligned in time. The techniques described herein may be used for either synchronous or asynchronous operations.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device (PLD), discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can include RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for wireless communications at a user equipment (UE), comprising:
identifying that the UE is configured to operate in a discontinuous reception (DRX) mode, wherein each DRX period includes an active duration and an inactive duration;
identifying that the UE is configured to perform a beam failure detection (BFD) procedure; and
monitoring for beam failure in accordance with the BFD procedure during the active duration of the DRX period.

2. The method of claim 1, further comprising:
operating a timer in accordance with the BFD procedure, wherein expiration of the timer results in a beam failure counter being reset.

3. The method of claim 1, wherein monitoring for beam failure comprises:
monitoring for beam failure based on the UE entering the active duration of the DRX period.

4. The method of claim 1, wherein monitoring for beam failure comprises:
monitoring one or more reference signals associated with BFD, wherein the monitoring is based at least in part on a periodicity of transmission of the one or more reference signals.

5. The method of claim 4, wherein monitoring the one or more reference signals comprises:
performing link quality measurements based at least in part on the one or more reference signals with a same periodicity as the periodicity of transmission of the one or more reference signals.

6. The method of claim 1, wherein monitoring for beam failure comprises:
monitoring one or more beams associated with BFD reference signals, wherein the monitoring is based at least in part on a periodicity of an expected coherence time of the one or more beams.

7. The method of claim 1, wherein monitoring for beam failure comprises:
monitoring for beam failure in accordance with a periodicity, wherein the periodicity is based at least in part on the DRX period and a shortest periodicity for transmission of BFD reference signals.

8. The method of claim 1, wherein monitoring for beam failure comprises:
monitoring for beam failure in accordance with a periodicity, wherein the periodicity is based at least in part on the DRX period.

9. The method of claim 1, further comprising:
receiving an indication that the UE is to perform the BFD procedure during the active duration of the DRX period.

10. The method of claim 1, further comprising:
refraining from resetting a beam failure counter during the inactive duration of the DRX period.

11. An apparatus for wireless communications, comprising:
a processor,
memory in electronic communication with the processor; and
instructions stored in the memory and executable by the processor to cause the apparatus to:
identify that the apparatus is configured to operate in a discontinuous reception (DRX) mode, wherein each DRX period includes an active duration and an inactive duration;
identify that the apparatus is configured to perform a beam failure detection (BFD) procedure; and
monitor for beam failure in accordance with the BFD procedure during the active duration of the DRX period.

12. The apparatus of claim 11, wherein the instructions are further executable by the processor to cause the apparatus to:
operate a timer in accordance with the BFD procedure, wherein expiration of the timer results in a beam failure counter being reset.

13. The apparatus of claim 11, wherein the instructions to monitor for beam failure are executable by the processor to cause the apparatus to:
monitor for beam failure based on the apparatus entering the active duration of the DRX period.

14. The apparatus of claim 11, wherein the instructions to monitor for beam failure are executable by the processor to cause the apparatus to:
monitor one or more reference signals associated with BFD, wherein the monitoring is based at least in part on a periodicity of transmission of the one or more reference signals.

15. The apparatus of claim 14, wherein the instructions to monitor the one or more reference signals are executable by the processor to cause the apparatus to:
perform link quality measurements based at least in part on the one or more reference signals with a same periodicity as the periodicity of transmission of the one or more reference signals.

16. The apparatus of claim 11, wherein the instructions to monitor for beam failure are executable by the processor to cause the apparatus to:
monitor one or more beams associated with BFD reference signals, wherein the monitoring is based at least in part on a periodicity of an expected coherence time of the one or more beams.

17. The apparatus of claim 11, wherein the instructions to monitor for beam failure are executable by the processor to cause the apparatus to:
monitor for beam failure in accordance with a periodicity, wherein the periodicity is based at least in part on the DRX period and a shortest periodicity for transmission of BFD reference signals.

18. The apparatus of claim 11, wherein the instructions to monitor for beam failure are executable by the processor to cause the apparatus to:
monitor for beam failure in accordance with a periodicity, wherein the periodicity is based at least in part on the DRX period.

19. The apparatus of claim 11, wherein the instructions are further executable by the processor to cause the apparatus to:
receive an indication that the apparatus is to perform the BFD procedure during the active duration of the DRX period.

20. The apparatus of claim 11, wherein the instructions are further executable by the processor to cause the apparatus to:
refrain from resetting a beam failure counter during the inactive duration of the DRX period.

21. An apparatus for wireless communications, comprising:
means for identifying that the apparatus is configured to operate in a discontinuous reception (DRX) mode, wherein each DRX period includes an active duration and an inactive duration;
means for identifying that the apparatus is configured to perform a beam failure detection (BFD) procedure; and
means for monitoring for beam failure in accordance with the BFD procedure during the active duration of the DRX period.

22. The apparatus of claim 21, further comprising:
means for operating a timer in accordance with the BFD procedure, wherein expiration of the timer results in a beam failure counter being reset.

23. The apparatus of claim 21, wherein the means for monitoring for beam failure comprises:
means for monitoring for beam failure based on the apparatus entering the active duration of the DRX period.

24. The apparatus of claim 21, wherein the means for monitoring for beam failure comprises:
means for monitoring one or more reference signals associated with BFD, wherein the monitoring is based at least in part on a periodicity of transmission of the one or more reference signals.

25. The apparatus of claim 21, wherein the means for monitoring for beam failure comprises:
means for monitoring one or more beams associated with BFD reference signals, wherein the monitoring is based at least in part on a periodicity of an expected coherence time of the one or more beams.

26. The apparatus of claim 21, wherein the means for monitoring for beam failure comprises:
means for monitoring for beam failure in accordance with a periodicity, wherein the periodicity is based at least in part on the DRX period and a shortest periodicity for transmission of BFD reference signals.

27. The apparatus of claim 21, wherein the means for monitoring for beam failure comprises:
means for monitoring for beam failure in accordance with a periodicity, wherein the periodicity is based at least in part on the DRX period.

28. The apparatus of claim 21, further comprising:
means for receiving an indication that the apparatus is to perform the BFD procedure during the active duration of the DRX period.

29. The apparatus of claim 21, further comprising:
means for refraining from resetting a beam failure counter during the inactive duration of the DRX period.

30. A non-transitory computer-readable medium storing code for wireless communications at a user equipment (UE), the code comprising instructions executable by a processor to:
identify that the UE is configured to operate in a discontinuous reception (DRX) mode, wherein each DRX period includes an active duration and an inactive duration;
identify that the UE is configured to perform a beam failure detection (BFD) procedure; and
monitor for beam failure in accordance with the BFD procedure during the active duration of the DRX period.
